(19) United States
(12) Patent Application Publication
(10) Pub. No.: US 2005/0246169 A1
(43) Pub. Date: Nov. 3, 2005

(54) Detection of the audio activity

(75) Inventor: Tommi Lahti, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/117,636

(22) Filed: Apr. 22, 2005

(30) Foreign Application Priority Data
Apr. 22, 2004 (FI) 20045146

(51) Int. Cl. G10L 11/00

(52) U.S. Cl. 704/215

(57) ABSTRACT

The invention relates to a method for detecting audio activity. In the method samples of audio signal are formed or received. A feature vector is formed from the samples of the audio signal and the feature vector is projected by a discriminant vector to form a projection value for the feature vector. A statistical value of a number of projection values is calculated, a minimum value and a maximum value of said number of projection values are detected. The method further comprises determining the existence of monitored audio activity on the basis of said minimum value, said maximum value and the projection value. The invention also relates to a speech decoder, a system, an electronic device, a module and a computer program product.

### CROSS-REFERENCE TO RELATED APPLICATIONS

This application claims priority under 35 USC §119 to Finnish Patent Application No. 20045146 filed on Apr. 22, 2004.

### FIELD OF THE INVENTION

The present invention relates to a method for detecting audio activity comprising forming or receiving samples of an audio signal, forming a feature vector from the samples of the audio signal, and projecting the feature vector by a discriminant vector to form a projection value for the feature vector. The invention also relates to a speech recognizer comprising a detector for detecting audio activity; a sampler for forming samples of an audio signal, a feature vector forming block to form a feature vector from the samples of the audio signal, a discriminator for projecting the feature vector by a discriminant vector to form a projection value for the feature vector. The invention also relates to an electronic device comprising a sampler for forming or receiving samples of an audio signal; a feature vector forming block to form a feature vector from said samples of the audio signal; and discriminator for projecting the feature vector by a discriminant vector to form a projection value for the feature vector. The invention relates to a module for detection of audio activity comprising an input for receiving a projection value for a feature vector, which feature vector is formed from samples of an audio signal, and which projection value is formed by projecting the feature vector by a discriminant vector. The invention further relates to a computer program product comprising machine executable steps for detecting audio activity comprising forming or receiving samples of an audio signal; forming a feature vector from said samples of the audio signal; projecting the feature vector by a discriminant vector to form a projection value for the feature vector. The invention still further relates to a system comprising a sampler for forming or receiving samples of an audio signal; a feature vector forming block to form feature vectors from said samples of the audio signal; a discriminator for projecting the feature vector by a discriminant vector to form a projection value for the feature vector.

### BACKGROUND OF THE INVENTION

The Beginning of Audio Activity (BAA) and End of Audio Activity (EAA) detection is an important feature in isolated word speech recognition systems, name dialling, SMS dictation for multimedia applications, general voice activity detection etc. The aim of BAA and EAA detection is to detect the time where the audio activity begins and ends as reliably and quickly as possible. When the BAA detection has been performed the recognizing system can start processing the detected audio signal. The processing can be ended after EAA is detected. With reliable BAA and EM detection unnecessary and costly computation done by the recognition system can be avoided. The recognition rate can also be improved since a noisy part possibly existing before the audio activity can be omitted.

Both the BAA and EAA represent some kind of changes in audio activity wherein the term “change in audio activity” is used instead of BAA or EAA at some parts of this description.

Decoding in Automatic Speech Recognition (ASR) is a computationally expensive and time consuming task. It is useless to perform decoding for non-audio activity data and especially in noisy environments it can even cause performance degradation to the automatic audio activity recognition system. A simple but robust beginning of audio activity detection algorithm would be ideal for many automatic audio activity recognition tasks as listed above.

Many existing automatic audio activity recognition systems include a signal processing front-end that converts the audio activity waveform into feature parameters. One of the most used features is the Mel Frequency Cepstrum Coefficients (MFCC). Cepstrum is the Inverse Discrete Cosine Transform (IDCT) of the logarithm of the short-term power spectrum of the signal. One advantage of using such coefficients is that they reduce the dimension of an audio activity spectral vector.

In prior art systems there are also some other algorithm-related problems. For example, many algorithms usually work nicely in clean, noiseless environments but if there is noise present the algorithms can often fail even if the signal to noise ratio (SNR) of the audio activity signal is fairly high. The frequency spectrum coefficient (FCC) features and/or methods utilizing the energy of the signal that are commonly used in audio activity recognition clearly do not provide satisfactory features for beginning of audio activity detection. Additive noise is also difficult to compensate.

Many different techniques have been developed for solving the BAA and EAA problem. For example, there exist many energy and zero crossing based methods in which the energy of the audio signal is measured and zero crossing points are detected. However, these methods often prove to be either unreliable especially in noise or are unnecessarily complex. Often the BAA and EM detection is obtained from an algorithm as a side effect. For example, the actual algorithm may be aimed to solve more general problems like speech/non-speech detection or voice activity detection problems but which are not important features for the BAA or EAA detection. Stripping of the unnecessary part does not lead to good performance or may be totally impossible.

One prior art method for speech/non-speech detection is disclosed in a publication “Robust speech/non-speech detection using LDA applied to MFCC”; Martin, A.; Charlet, D.; Mauuary, L.; Proceedings. (ICASSP '01). 2001 IEEE International Conference on Acoustics, Speech, and Signal Processing, 2001, Volume: 1, 7-11 May 2001; Pages: 237-240 vol. 1. In this method a Linear Discriminant Analysis (LDA) is applied to MFCC.

However, there is room for improvements as the feature vector normalization and delta and ddelta calculations introduce some delay to the decoding. With the static MFCC features without normalization there is no delay and much can be done within the delayed time window.

### SUMMARY OF THE INVENTION

The invention tries to reduce the computational complexity of the recognition process for example for the SMS dictation task. Being able to discard non-audio activity data at the change in audio activity detection results in computational savings in decoding.

The present invention provides a way to utilize e.g. the Mel Frequency Cepstrum Coefficients feature more effectively in the audio activity detection. This is possible since MFCC calculation usually introduces some delay to the decoding because of dynamic coefficient calculations and feature vector normalization. Also the need for noise compensation can be avoided in a simple way, making the algorithm more robust against noise.

The invention is based on the idea that the LDA is applied on MFCC features and making the threshold used in the determination of change in audio activity adaptable. The adaptation of the threshold is based on calculation of some properties of feature vectors formed from the speech signal.

According to one aspect of the invention there is provided a method for detecting a change in audio activity comprising:
forming or receiving samples of an audio signal,
forming a feature vector from the samples of the audio signal,
projecting the feature vector by a discriminant vector to form a projection value for the feature vector.

The method is primarily characterized in that the method further comprises
calculating a statistical value of a number of projection values,
detecting a minimum value and a maximum value of said statistical value of a number of projection values, and
determining the audio activity on the basis of said minimum value, said maximum value and the statistical value of a number of projection values.

According to an example embodiment of the method of the present invention the BAA is detected when the first statistical value of projected values classified as audio activity is found from the number of projected values and EAA is detected when the first statistical value of projected values has remained below threshold value for a predefined amount of samples.

According to another aspect of the invention there is provided a speech recognizer comprising:
a sampler for forming or receiving samples of an audio signal,
a feature vector forming block to form a feature vector from the samples of the audio signal,
a discriminator for projecting the feature vector by a discriminant vector to form a projection value for the feature vector.

The speech recognizer is primarily characterized in that the speech recognizer further comprises
a calculating block for calculating a statistical value of said projection value,
a detector for detecting the speech activity.

According to a third aspect of the invention there is provided an electronic device comprising:
a sampler for forming or receiving samples of an audio signal,
a feature vector forming block to form a feature vector from said samples of the audio signal,
a discriminator for projecting the feature vector by a discriminant vector to form a projection value for the feature vector.

The electronic device is primarily characterized in that the electronic device further comprises:
a calculation block for calculating a statistical value of said projection value,
a detector for detecting a beginning of audio activity.

According to a fourth aspect of the invention there is provided a module for detection of audio activity comprising an input for receiving a projection value for a feature vector, which feature vector is formed from samples of an audio signal, and which projection value is formed by projecting the feature vector by a discriminant vector. The module is primarily characterized in that the module further comprises:
a calculation block for calculating a statistical value of a number of projection values, and
a detector for detecting a beginning of audio activity.

According to a fifth aspect of the invention there is provided a computer program product comprising machine executable steps for detecting audio activity comprising:
forming or receiving samples of an audio signal,
forming a feature vector from said samples of the audio signal,
projecting the feature vector by a discriminant vector to form a projection value for the feature vector.

The computer program product is primarily characterized in that the method further comprises machine executable steps for:
calculating a statistical value of a number of projection values,
determining whether the monitored audio activity has begun on the basis of said minimum value, said maximum value and said projection value.

According to a sixth aspect of the invention there is provided a system comprising:
a sampler for forming or receiving samples of an audio signal,
a feature vector forming block to form feature vectors from said samples of the audio signal,
a discriminator for projecting the feature vector by a discriminant vector to form a projection value for the feature vector.

The system is primarily characterized in that the system further comprises:
a calculation block for calculating a statistical value of said projection values, and
a detector for detecting a beginning of audio activity.

In an example embodiment of the present invention the statistical values are magnified, when necessary, by some value before performing the comparisons.

The present invention provides a less complicated method and system for audio activity detection compared to prior art. The performance of prior art systems is often insufficient if noise is present, at least compared to how much computation power they use.

### DESCRIPTION OF THE DRAWINGS

FIG. 1 illustrates speech and non-speech distributions in a prior art system,

FIG. 2 illustrates speech and non-speech distribution in a system according to an example embodiment of the present invention,

FIG. 3a illustrates a sample of a speech signal,

FIG. 3b illustrates the behaviour of the mean LDA projection values in different environments,

FIG. 4 shows an example embodiment of a speech recognizer according to the present invention,

FIG. 5a shows the main blocks of an audio activity detection according to the present invention,

FIG. 5b shows the beginning of audio activity block of FIG. 5a as a simplified block diagram,

FIG. 6a shows the main blocks of EAA detection according to the present invention,

FIG. 6b shows the EAA block of FIG. 6a as a simplified block diagram, and

FIG. 7 shows an example of an electronic device according to the present invention as a simplified block diagram.

### DETAILED DESCRIPTION OF THE INVENTION

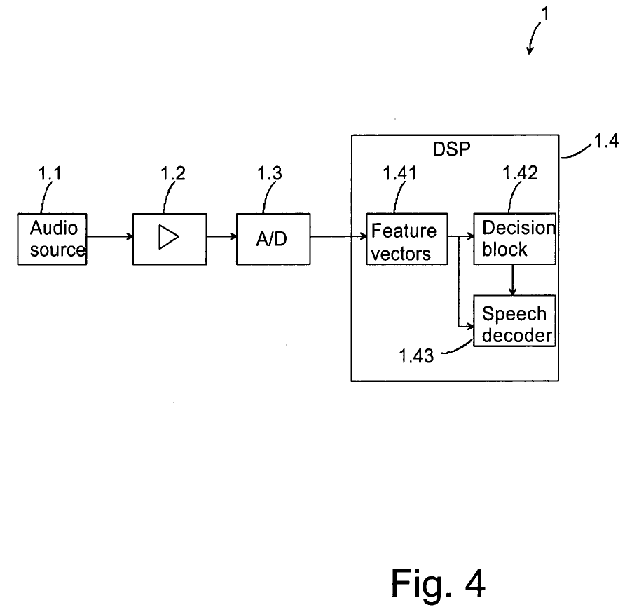

The invention will now be described in more detail with reference to the audio activity recognizer 1 presented in FIG. 4. The audio activity recognizer 1 has audio input 1.1 for inputting an audio signal for recognition. The audio input 1.1 is, for example, a microphone. The audio signal is amplified, when necessary, by the amplifier 1.2. The audio signal is also digitized in an analog/digital converter 1.3. The analog/digital converter 1.3 usually forms samples from the audio signal at certain intervals i.e. at a certain sampling rate. The digitized audio signal is divided into speech frames which means that a certain length of the audio signal is processed at one time. The length of the frame is usually a few milliseconds, for example 20 ms. After the analog/digital conversion a speech frame is represented by a set of samples. The speech recognizer 1 also has a speech processor 1.4 in which the calculations for the audio activity recognition are performed. The speech processor 1.4 is, for example, a digital signal processor (DSP).

The samples of the audio signal are input to the speech processor 1.4. In the speech processor 1.4 the samples are processed on a frame-by-frame basis i.e. each sample of one frame is processed to perform a feature extraction on the speech frame. The feature extraction forms a feature vector for each speech frame input to the speech recognizer 1. The coefficients of the feature vector relate to some sort of spectrally based features of the frame. The feature vectors are formed in a feature vector forming block 1.41 of the speech processor by using the samples of the audio signal. This block can be implemented e.g. as a set of filters each having a certain bandwidth. Together the filters cover the whole bandwidth of the audio signal. The bandwidths of the filters may partly overlap with some other filters. The outputs of the filters are transformed, such as discrete cosine transformed (DCT) wherein the result of the transformation is the feature vector. In this example embodiment of the present invention the feature vectors are 13-dimensional vectors but it should be evident that the invention is not limited to such vectors only. In this example embodiment the feature vectors are Mel Frequency Cepstrum Coefficients.

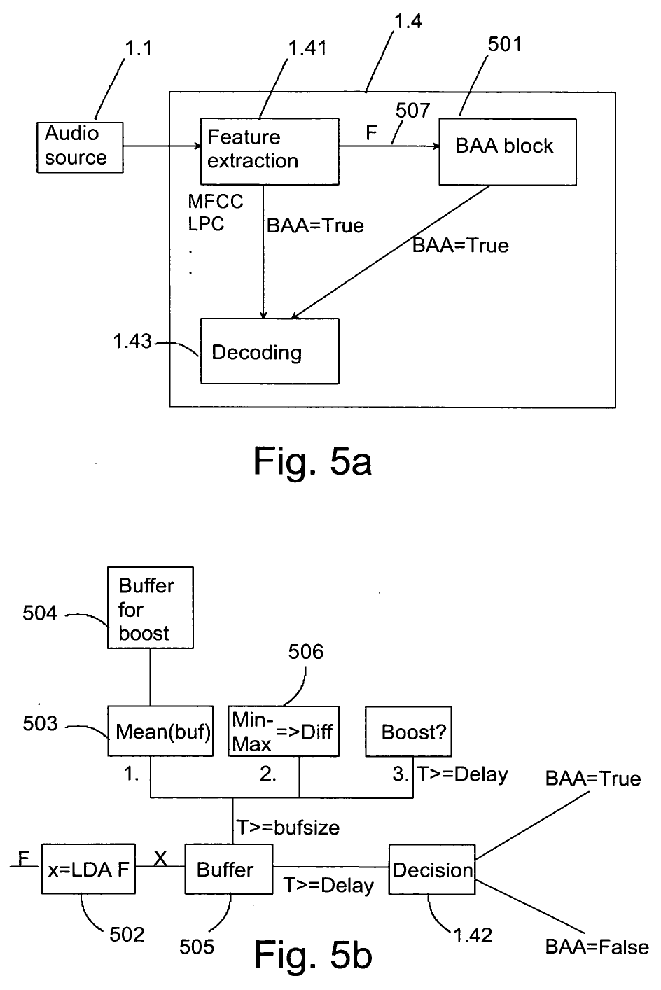

In the speech processor 1.4 the feature vectors are then projected to a one-dimensional line vector to represent each feature vector as a single value (block 502 in FIG. 5b). The projection may be linear or non-linear. One known projection method is the above mentioned Linear Discriminant Analysis (LDA) which is a statistical approach for classifying samples of unknown classes. In the LDA method a number of classes are defined and a projection basis (a discriminant vector) is determined based on training samples with known classes. Therefore, the speech processor 1.4 has been trained, for example, by a person or by multiple persons who has/have uttered the words and the audio signal is analyzed and classified. The speech processor 1.4 defines the projection parameters on the basis of the utterances. For the audio activity detection the number of classes can be two (audio activity is present/audio activity is not present).

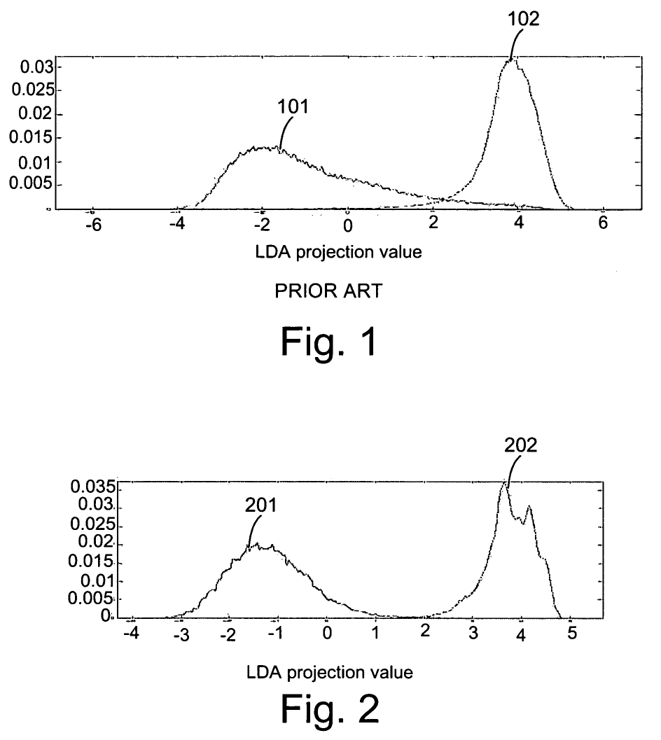

The projected value is then used to determine which class the feature vector (i.e. the speech frame) belongs to. Block 501 in FIG. 5a depicts the audio activity detector which is shown in more detail in FIG. 5b. In the present invention a single value is not used in the decision but more than one value are combined (block 503) before the decision is performed. To perform the combining the projected values are buffered in a buffer 504. The projected values may also be buffered 505 for the speech decoder 1.43. In an example embodiment a mean value is calculated over a period of time, i.e. using projected values of feature vectors of more than one speech frame. As an example the mean value is calculated from twenty projected values of twenty successive frames. The mean value is calculated for each successive frame after the twenty frames have been processed. In other words, the first mean value is calculated by using the projected values of the first twenty frames (frames 1-20), the second mean value is calculated by using frames 2-21 and so on. The first mean value is then used instead of the projected value of the first frame, the second mean value is used instead of the projected value of the second frame, etc. FIG. 1 illustrates an example of the LDA calculation without the calculation of the mean value. The curve 101 represents the LDA projected values which are classified as non-audio active and the curve 102 represents the LDA projected values which are classified as audio active. FIG. 2 illustrates the result after the method according to the invention is used i.e. the mean values are calculated. The curve 201 represents the distribution of the mean of the LDA projected values which are classified as non-audio active and the curve 202 represents the distribution of the mean of the LDA projected values which are classified as audio activity. It can be seen by comparing the curves of FIG. 1 with the respective curves of FIG. 2 that the windowing principle of the invention can improve the separation of audio active and non-audio active classification.

In principle, it is now possible to set a threshold (THRESHOLD_DISTRIBUTIONS) based on these mean value distributions and state that BAA occurred if the LDA projection value is above the threshold. The selection of the discriminant vector can inter alia affect on the way the result of the comparison should be interpreted.

The speech processor 1.4 also keeps track on the minimum (min) and maximum (max) mean values and the difference (diff) of the maximum and minimum mean values (block 506) while calculating the mean values. The minimum, maximum and the difference are used when determining the BAA for example as follows. After calculating the mean value, min, max and diff values for the current frame, the decision block 1.42 compares the maximum mean value to a predetermined high noise parameter (THRESHOLD_HIGH_NOISE) and if the maximum mean value is greater than the value of the high noise parameter the decision block 1.42 determines that the audio activity has already started or the noise level is high. The decision block 1.42 gives a signal indicative of beginning of audio activity to a speech decoder 1.43 of the speech recognizer 1. This signal triggers the speech decoding in the speech decoder 1.43. If, however, the maximum mean value is below the high noise parameter value, the decision block 1.42 compares the difference with a predetermined first min/max difference parameter value. This parameter is set so that if the difference between the maximum and minimum mean values is greater than the first min/max difference parameter value it is supposed that audio activity has already started. When the difference between the maximum and minimum mean values does not exceed the first min/max difference parameter value and the maximum mean value is less than the high noise parameter value, the decision block 1.42 compares the difference value with a predetermined second min/max difference parameter value. If the comparison indicates that the difference value is greater than the second min/max difference parameter value the decision block 1.42 compares the projection value of a current frame with a distribution threshold value. If the projection value of the current frame is greater than the distribution threshold value the decision block 1.42 determines that audio activity has started.

It should be evident that the comparison of the projection value of the current frame and the distribution threshold value can also be performed before the comparison of the second min/max parameter values and the difference value. Also the order of the other comparisons need not be the same as mentioned above. If none of the comparisons mentioned above produce a BAA indication the procedure will be repeated for the next frame, if not stopped for some other reason.

The decision criteria for the BAA triggering in the example embodiment of the invention described above can also be represented as the following pseudo code:

BAA = TRUE IF ( Max > THRESHOLD_HIGH_NOISE ||

(Diff > THRESHOLD_MIN_MAX_DIFF_1 &&
Max > THRESHOLD_DISTRIBUTIONS) ||
Diff > THRESHOLD_MIN_MAX_DIFF_2)

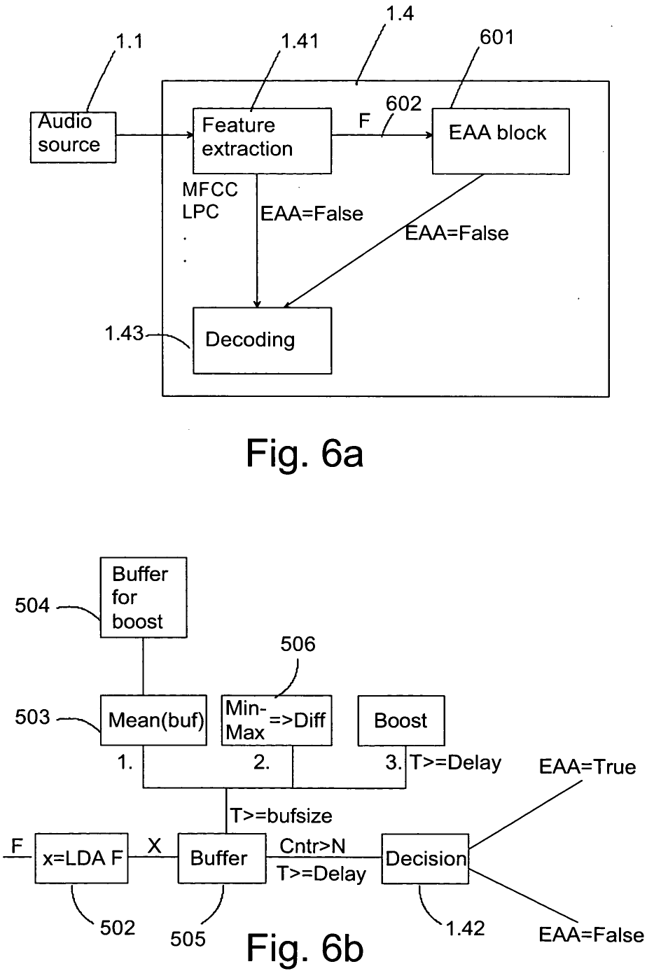

It is possible to use the same means for EAA detection. This is illustrated in FIGS. 6a and 6b as a simplified diagram. The block 601 in FIG. 6a illustrates the EAA decision block which may have common functional blocks with the BAA detection blocks of FIGS. 5a and 5b. If the underlying system introduces delay to the system it can be used as well for the EAA detection without introducing extra delay to the system. However, because it might be that the audio activity is e.g. speech formed from several words, it is likely that there is a pause between words. For this reason the EAA decision may need to be based on said predefined number of unbroken positive EAA decisions. It should be noted that this predefined amount of frames is not necessarily a fixed constant, but may vary e.g. according to a threshold or some other time-dependant variable. In order to make the min-max comparison sensible, the maximum value must be updated so that it is the minimum of the values observed after the time when BAA was detected in EAA detection. In the min-max comparison a third min/max difference parameter (THRESHOLD_MIN_MAX_DIFF_EM) may be used. The high noise parameter (THRESHOLD_HIGH_NOISE) is not needed in the EM detection.

The decision criteria for EAA triggering in the example embodiment of the invention described above can also be represented as the following pseudo code:

Given that the BAA has already been detected or it is otherwise desired to start detecting the EAA:

Cntr=0
set Max = INF
For each T {

IF ( Mean LDA value < Max )

Max = Mean LDA value

IF ( Diff < THRESHOLD_MIN_MAX_DIFF_EAA ) {

Cntr++

}
ELSE

Cntr=0

IF ( Cntr > N )

EAA=TRUE

}

In the pseudo code the counter Cntr is cleared. The purpose of the counter Cntr is to count the number of non-audio activity frames to differentiate pauses between words from EAA. The maximum parameter Max is set to a maximum value INF because the purpose of the maximum parameter is to find the smallest of the maximum mean LDA values (or smallest maximum of some other statistical value). This smallest maximum value is then used in the min-max difference analysis. The pseudo code comprises a loop which is repeated for each frame until the condition to exit the loop is found. In the loop the mean LDA value of the current frame is compared with the value of the maximum parameter Max. If the mean LDA value is smaller than the value of the Max, the mean LDA value is set as the new value of the maximum parameter Max. Then, the difference of the maximum Max and minimum Min is compared with the third min/max difference parameter THRESHOLD_MIN_MAX_DIFF_EM. In the calculation of the min/max difference the minimum value is the global minimum value (i.e. the smallest of the mean LDA values). If the difference is smaller than the value of the third min/max difference parameter THRESHOLD_MIN_MAX_DIFF_EM the counter Cntr is increased. Otherwise the counter is cleared. At the end of the loop the value of the counter Cntr is compared with the predefined number N of unbroken positive EM decisions. If the value of the counter Cntr is greater than the predefined number N it is determined that the audio activity has ended and the EM parameter is set true and the loop is exited. Otherwise the loop will be repeated for the next frame.

The frames are not necessarily examined continuously but in groups. For example, the speech recognizer 1 buffers forty-seven frames and after that begins the calculation and BAA detection. If no audio activity is detected on the buffered frames the speech recognizer 1 buffers the next forty-seven frames and repeats the calculation and BAA detection.

When the speech recognizer 1 has detected the BAA frame (i.e. the frame in which the BAA had the value true) it informs the speech decoder 1.43 the frame number so that the speech decoder 1.43 can begin the decoding of the speech. It is also possible that the speech decoder 1.43 starts the decoding predefined amount of frames before the BAA frame. Similarly the speech decoder ends decoding after a predefined amount of frames after EAA detection. It should be noted that these predefined amounts of frames are not necessarily fixed constants, but may vary e.g. according to threshold or some other time-dependant variable.

It is also possible to use another statistical value instead of the mean value in the calculations described above.

It should be noted that the data used in training the discriminant vector in the case of FIGS. 1 and 2 was obtained from clean speech samples only. For this reason the effect of noise needs to be studied further.

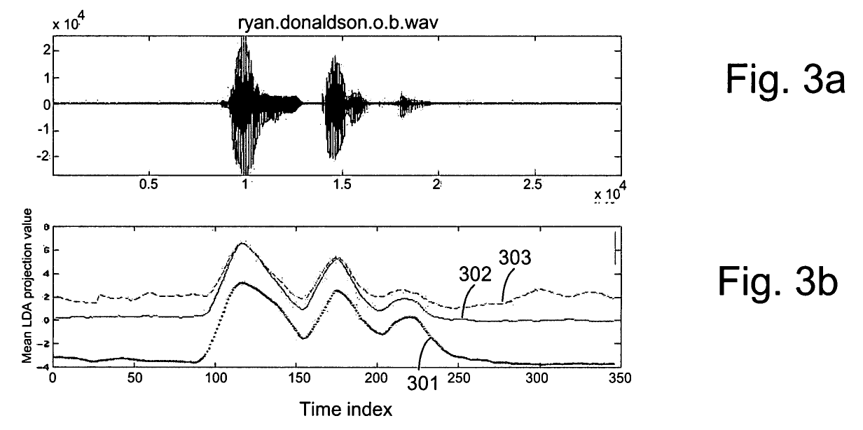

The discriminant vector corresponding to the FIGS. 1 and 2 above is
v=(−0.0205, −0.1355, −0.0292, −0.1206, 0.0060, 0.0863, −0.0407, −0.2307, −0.1286, −0.2852, −0.1591, −0.2092, −0.8581)^{T}
the corresponding MFCC feature vector components being c1, c2, . . . , c12 and c0 respectively. If the component values of the vector v are interpreted as weights on how much each MFCC component (variable) contributes to the LDA projection it can be seen that the energy term c0 clearly dominates. Indeed, it was noted during the development work that, in noise, the distributions tend to move (“slide”) to the direction of the speech distribution. This is illustrated in FIG. 3b for one fixed audio activity in three different environments (clean, vw115 10 dB and background speech 10 dB). The FIG. 3a illustrates the speech signal.

Adding noise to the speech sample does not necessarily mean that the minimum and maximum values are shifted up (in case similar to the FIG. 3b) equally. In FIG. 3b it is illustrated what is more likely to happen. The difference between the min and max values in the clean line case (curve 301) is about 7, in vw115 case (curve 302) about 6 and in background case (curve 303) only about 4 anymore. In many cases the “shrinking” is lot more obvious. This can have some effects on the beginning of audio activity decision logic.

In the following another embodiment of the operation of the decision block 1.42 will be described. After calculating the mean value, min, max and diff values for the current frame, the decision block 1.42 compares the maximum mean value to a predetermined high noise parameter the same way as in the embodiment described above. If the maximum mean value is below the high noise parameter value, the decision block 1.42 examines the noise level of the signal. It can be performed, for example, by examining the minimum mean value. If the minimum mean value is relatively high it can be assumed that there is noise in the signal. The decision block 1.42 can compare the minimum mean value with a noise level parameter and if the minimum mean value exceeds the noise level parameter the decision block 1.42 continues the operation as follows. The decision block 1.42 buffers the mean values of the frames under consideration and calculates the median of the mean values and compares it with the distribution threshold. If the median is greater than the distribution threshold, the mean values are magnified (multiplied) by some constant greater than one (e.g. by 2) before performing the comparisons as described above. Also some linear or non-linear functions could be considered here so that the magnification is not based on a constant value but on a function. This way it is possible to set a common threshold (THRESHOLD_MIN_MAX_DIFF) for the differences between min and max mean LDA values for both clean and noise. This can be seen through the result below.

In the clean case the differences between non-speech and speech parts are quite obvious if the mean LDA projection values are checked. A threshold could be set to the mean LDA values so that speech and non-speech parts are well separated. However, since there is shifting due to the noise the difference between the minimum and maximum values as a function of time are checked. Because of the shrinking in noise the mean LDA projection values are multiplied by some constant if noise is considered to be substantial. For this reason mean LDA values are buffered and their median is calculated when there is no delay compared to the decoding. The median value is compared against the threshold and the mean LDA values are magnified by some constant which is greater than one (e.g. two) if the threshold is exceeded (also some linear functions could be considered). This way it is possible to set a common threshold (THRESHOLD_MIN_MAX_DIFF) for the differences between min and max mean LDA values for both clean and noise. This can be seen through the result below.

In the following some details about the tests performed with a speech recognizer 1 are described. For training the LDA projection vector some speech samples were used from a name database. Only clean training data was used. Multi environment training could be tried but the shifting phenomenon would be present still with high probability. Static MFCC feature vectors were obtained from the recognizer for each speech sample and read into a Matlab-program. Based on the speech starting point (SSP) labels that were generated with the recognizer the feature vectors were divided into two classes. Non-speech class was formed directly from the feature vectors that were observed before the point SSP−10. The reason for the minus ten is that the transition part could better be discarded. For the speech class only 40 feature vectors from the file just after the point SSP+10 were qualified. The reason for this was that with this arrangement there would be practically only feature vectors corresponding to speech frames. Then LDA was performed on the feature vectors with the class information and the number of discriminant vectors was set to one. The discriminant vector was then used in the algorithm described in this application. The speech and non-speech distributions for the training data are close to those shown in FIGS. 1 and 2.

It is also possible to implement the present invention as a module which can be connected with an electronic device comprising a speech decoder, wherein the module produces a change in audio activity indication to the electronic device or directly to the speech decoder of the electronic device. One example embodiment of the module comprises the decision block 1.42 but also other constructions for the module are possible.

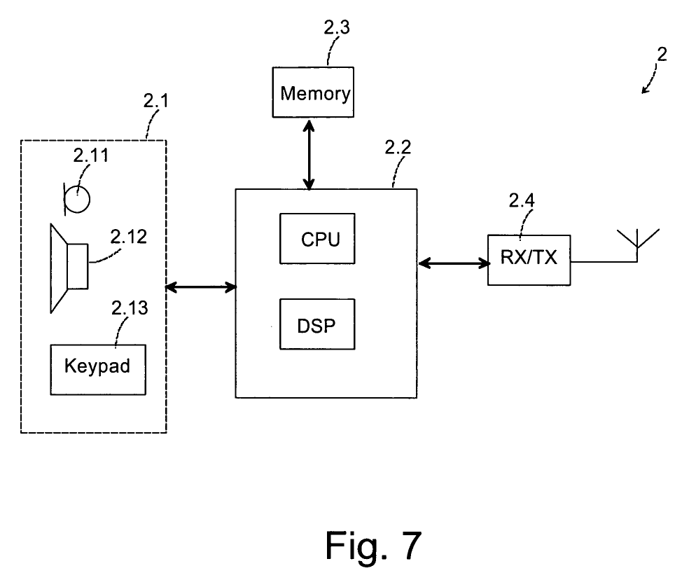

The electronic device in which the invention can also be implemented can be any electronic device in which the change in audio activity detection may be used. In FIG. 7 is depicted as a simplified block diagram an example of an electronic device 2 according to the present invention. It comprises a user interface 2.1 comprising e.g. a microphone 2.11 as the audio source 1.1, a loudspeaker 2.12 and a keypad 2.13. The electronic device 2 also comprises a control block 2.2 for controlling the operations of the electronic device 2, and a memory 2.3 for storing information, programs etc. The control block 2.2 comprises, for example, a processor CPU, a digital signal processor DSP, etc. Therefore, at least some of the operations of the present invention can be implemented as a computer program which comprises machine executable steps for performing at least some of the operations for BAA/EAA detection. Further, the electronic device 2 can comprise a transceiver 2.4 for mobile communication. As non-limiting examples of such electronic devices one can mention mobile communication devices, computing devices, locks, remote controllers, etc.

The present invention can be used in detection of changes in audio activity. For example, the invention can be used for BAA detection, for EAA detection or for both BAA and EAA detection.

It should be understood that the present invention is not limited solely to the above described embodiments but it can be modified within the scope of the appended claims.

1. The method for detecting the audio activity comprising:
forming or receiving samples of an audio signal;
forming feature vectors from said samples of the audio signal;
projecting said feature vector by a discriminant vector to form a projection values for said feature vectors;
calculating a statistical value of a number of projection values; and
determining the audio activity on the basis of said statistical value.

2. The method according to claim 1, wherein said calculation of said statistical value is calculated as a running statistical value.

3. The method according to claim 1, wherein said calculation of said statistical value is calculated by frames.

4. The method according to claim 1, wherein said statistical value is calculated by calculating a mean value of said projection values.

5. The method according to claim 1, wherein a minimum value and a maximum value of said statistical value of projection values is detected.

6. The method according to claim 5, wherein it is determined whether the monitored audio activity has begun on the basis of said minimum value, said maximum value and said projection value.

7. The method according to claim 1, wherein the audio activity is detected when said statistical value classified as audio activity frame is found from the number of said projected values.

8. The method according to claim 1, wherein said determining comprises comparing the maximum value with a predetermined high noise threshold value to determine whether the monitored audio activity has begun.

9. The method according to claim 8, wherein it further comprises comparing the difference of the maximum value and the minimum value with a first difference threshold to determine whether the monitored audio activity has begun if said comparison of the maximum value with a predetermined high noise threshold value did not indicate that the monitored audio activity has begun.

10. The method according to claim 9, wherein it further comprises comparing the difference of the maximum value and the minimum value with a second difference threshold to determine whether the monitored audio activity has begun if said comparison of the difference of the maximum value and the minimum value with a first difference threshold did not indicate that the monitored audio activity has begun.

11. The method according to claim 10, wherein it further comprises comparing the projection value of a frame with a threshold value to determine whether the monitored audio activity has begun if said comparison of the difference of the maximum value and the minimum value with a second difference threshold did not indicate that the monitored audio activity has begun.

12. The method according to claim 1, wherein it comprises comparing the projection value of a frame with a threshold value to determine whether the monitored audio activity has begun.

13. The method according to claim 1, wherein it comprises magnifying said the statistical values by a magnifier before performing said determining.

14. Speech recognizer comprising:
a sampler for forming or receiving samples of an speech signal;
a feature vector forming block to form feature vectors from the samples of said speech signal;
a discriminator for projecting said feature vectors by a discriminant vector to form projection values for the feature vectors;
a calculation block for calculating a statistical value of a number of said projection values; and
a detector for detecting the speech activity.

15. The speech recognizer according to claim 14, wherein said calculation block is arranged to perform said calculation of said statistical value as a running mean.

16. The speech recognizer according to claim 14, wherein said calculation block is arranged to perform said calculation of said statistical value by frames.

17. The speech recognizer according to claim 14, wherein said calculation block is arranged to perform said calculation of said statistical value by calculating a mean value of said projection values.

18. The speech recognizer according to claim 14, wherein it contains means for detecting minimum and maximum value of said number of projection values.

19. The speech recognizer according to claim 18, wherein said detector comprises a classifier for classifying the projected values as speech activity or non-speech activity on the basis of said minimum value, said maximum value and said projection value.

20. The speech recognizer according to claim 14, wherein said detector comprises a comparator for comparing the maximum value with a predetermined high noise threshold value to determine whether the monitored audio activity has begun.

21. The speech recognizer according to claim 20, wherein said detector comprises a comparator for comparing the difference of the maximum value and the minimum value with a first difference threshold to determine whether the monitored audio activity has begun if said comparison of the maximum value with a predetermined high noise threshold value did not indicate that the monitored audio activity has begun.

22. The speech recognizer according to claim 21, wherein said detector comprises a comparator for comparing the difference of the maximum value and the minimum value with a second difference threshold to determine whether the monitored audio activity has begun if said comparison of the difference of the maximum value and the minimum value with a first difference threshold did not indicate that the monitored audio activity has begun.

23. The speech recognizer according to claim 22, wherein said detector comprises a comparator for comparing the projection value of a frame with a threshold value to determine whether the monitored audio activity has begun if said comparison of the difference of the maximum value and the minimum value with a second difference threshold did not indicate that the monitored audio activity has begun.

24. The speech recognizer according to claim 14, wherein said detector comprises a comparator for comparing the projection value of a frame with a threshold value to determine whether the monitored audio activity has begun.

25. The speech recognizer according to claim 14, wherein it comprises a magnifier for magnifying said mean values by a magnifier before performing said determining.

26. Electronic device comprising:
a sampler for forming or receiving samples of an audio signal;
a feature vector forming block to form feature vectors from said samples of the audio signal;
a discriminator for projecting the feature vector by a discriminant vector to form projection values for the feature vector;
a calculation block for calculating a statistical value of a number of said projection values;
a detector for detecting a beginning of audio activity.

27. The electronic device according to claim 26, wherein said calculation block is arranged to perform said calculation of said statistical value as a running mean.

28. The electronic device according to claim 26, wherein said calculation block is arranged to perform said calculation of said statistical value by frames.

29. The electronic device according to claim 26, wherein said calculation block is arranged to perform said calculation of said statistical value by calculating a mean value of said projection values.

30. The electronic device according to claim 26, wherein it contains means for detecting minimum and maximum value of said number of projection values.

31. The electronic device according to claim 30, wherein said detector comprises a classifier for classifying the projected values as audio activity or non-audio activity on the basis of said minimum value, said maximum value and said projection value.

32. Module for detection of audio activity comprising
an input for receiving projection values for feature vectors, which feature vectors are formed from samples of an audio signal, and which projection values are formed by projecting the feature vectors by a discriminant vector;
a calculation block for calculating a statistical value of a number of projection values; and
a detector for detecting a beginning of audio activity.

33. The module according to claim 32, wherein said calculation block is arranged to perform said calculation of said statistical value as a running mean.

34. The module according to claim 32, wherein said calculation block is arranged to perform said calculation of said statistical value by frames.

35. The module according to claim 32, wherein said calculation block is arranged to perform said calculation of said statistical value by calculating a mean value of said projection values.

36. The module according to claim 32, wherein it contains means for detecting minimum and maximum value of said number of projection values.

37. The module according to claim 36, wherein said detector comprises a classifier for classifying the projected values as audio activity or non-audio activity on the basis of said minimum value, said maximum value and said projection value.

38. Computer program product comprising machine executable steps for detecting audio activity comprising:
forming or receiving samples of an audio signal;
forming feature vectors from said samples of the audio signal;
projecting the feature vectors by a discriminant vector to form projection values for the feature vectors;
calculating a statistical value of a number of projection values;
determining whether the monitored audio activity has begun on the basis of said statistical value.

39. The computer program product according to claim 38, wherein the computer program product comprises machine executable steps for performing said calculation of said statistical value as a running mean.

40. The computer program product according to claim 38, wherein the computer program product comprises machine executable steps for performing said calculation of said statistical value by frames.

41. The computer program product according to claim 38, wherein the computer program product comprises machine executable steps for performing the calculation of said statistical value by calculating a mean value of said projection values.

42. The computer program product according to claim 38, wherein it contains machine executable steps for detecting minimum and maximum value of said number of projection values.

43. The computer program product according to claim 42, wherein said determination comprises machine executable steps for classifying the projected values as audio activity or non-audio activity on the basis of said minimum value, said maximum value and said projection value.

44. System comprising:
a sampler for forming or receiving samples of an audio signal;
a feature vector forming block to form feature vectors from said samples of the audio signal;
a discriminator for projecting the feature vectors by a discriminant vector to form projection values for the feature vectors;
a calculation block for calculating a statistical value of projection values;
a detector for detecting a beginning of audio activity.
